(19) United States
(12) Patent Application Publication
(10) Pub. No.: US 2011/0084492 A1
(43) Pub. Date: Apr. 14, 2011

(54) Vertical Propeller Fluid Energy Capture with Coordinated Dynamic-Orientation Blades

(75) Inventors: Gary L. Durham, Stuart, FL (US); H. Stephen Durham, Port Saint Lucie, FL (US)

(73) Assignee: Just the 4 of Us, LLC, Wichita, KS (US)

(21) Appl. No.: 12/902,139

(22) Filed: Oct. 11, 2010

Related U.S. Application Data
(63) Continuation-in-part of application No. PCT/US10/43000, filed on Jul. 23, 2010.
Application No. PCT/US10/43000 is a continuation-in-part of application No. 12/921,791.
(60) Provisional application No. 61/241,694, filed on Sep. 11, 2009.

(51) Int. Cl. F03D 9/00; F03D 7/02

(52) U.S. Cl. 290/55; 416/10

(57) ABSTRACT

A vertical propeller system for capturing wind energy includes a coupling module coupled to a drive shaft to impart rotational energy to the drive shaft. The drive shaft rotates about a substantially vertical main axis. A first blade couples to the coupling module and rotates about a first blade axis. The first blade progresses through a first continuous, repeating sequence of first blade orientations, which include a first substantially vertical orientation and a first substantially horizontal orientation. The first substantially vertical orientation presents a maximal cross-section to a wind stream, the wind stream having a wind direction. The first substantially horizontal orientation presents a minimal cross-section to the wind stream. The first blade revolves around the coupling module in response to the wind stream, based on the first blade orientation, imparting rotational energy to the coupling module. The coupling module aligns the first continuous, repeating sequence of blade orientations so that the first substantially vertical orientation occurs at a predetermined angle to the wind direction.

### TECHNICAL FIELD

The present invention relates generally to the field of mechanical energy transformation and, in particular, to a method and system for fluid energy capture in vertical propeller systems.

### BACKGROUND OF THE INVENTION

Modern vertical windmill design offers many important cost saving, efficiency, and maintenance features that horizontal windmill designs cannot provide as effectively. For example, some vertical windmill designs allow placement of the power generation unit on the ground instead of many meters in the air, which removes the cross-section of the power generation unit from the wind interaction area. As such, relocating the power generation unit encourages more efficient interaction of wing members with the wind, a wider wind speed tolerance for effective generation and, in some cases, lower overall height requirements for the same generating capacity. However, many common vertical windmill designs are unable to produce a wing design that interacts with the wind as efficiently as the propeller and wind-screw designs of horizontal windmills.

The most common attempted solution in vertical windmill wing designs has been to provide specially formed surfaces on the side of the wing intended to interact with the wind to create power on the shaft. These specially formed surfaces are usually intended to create high pressure behind the wing as it interacts with the wind rotating downwind. Typically, these specially formed surfaces are also intended to create low pressure in front of the wing as it interacts with the wind as it rotates upwind. Theoretically, in common systems, the differential between the pressure on the high-pressure surfaces traveling downwind and the low-pressure surfaces traveling upwind is supposed to result in a net gain of torque in one direction on the power shaft. Typically, however, common systems fail to achieve a significant net torque gain in practice.

For example, in typical systems, wing cross-sections shaped to create low pressure in front of the wing as it moves into the wind can only create this low pressure as an offset to its cross-sectional resistance to the wind as it rotates upwind, which creates a counter-torque on the wing, and thus the shaft. The upwind side design of the wing causes a low-pressure area in front of the wing that only partially offsets this cross-sectional counter-torque. Thus, the net torque of the wing traveling upwind is, though reduced, still a counter-torque on the windmill.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

In a general aspect of the invention, a vertical propeller system for capturing wind energy includes a coupling module configured to couple to a drive shaft so as to impart rotational energy from the coupling module to the drive shaft. The drive shaft rotates about a substantially vertical main axis. A first blade couples to the coupling module and rotates about a substantially horizontal first blade axis. The first blade progresses through a first continuous, repeating sequence of first blade orientations, which include a first substantially vertical orientation and a first substantially horizontal orientation. The first substantially vertical orientation presents a maximal cross-section to a wind stream, the wind stream having a wind direction. The first substantially horizontal orientation presents a minimal cross-section to the wind stream. The first blade is able to revolve around the coupling module in response to the wind stream, based on the first blade orientation, so as to impart rotational energy to the coupling module. The coupling module aligns the first continuous, repeating sequence of blade orientations so that the first substantially vertical orientation occurs at a predetermined angle to the wind direction.

In one embodiment, the coupling module comprises a gear box, the gear box being configured to change the alignment of the first continuous, repeating sequence of blade orientations. In one embodiment, the coupling module comprises a gear box, the gear box being configured to change the alignment of the first continuous, repeating sequence of blade orientations, based on the wind direction.

In one embodiment, wherein the coupling module comprises a sun gear and the first blade comprises a planet gear coupled to the sun gear. In one embodiment, the coupling module comprises a worm gear, the worm gear being configured to change the alignment of the first continuous, repeating sequence of blade orientations. In one embodiment, the coupling module comprises a frame coupled to the drive shaft and a gear box coupled to the frame and the first blade. In one embodiment, the coupling module is configured to change the alignment of the first continuous, repeating sequence of blade orientations based on a desired efficiency.

In one embodiment, the vertical propeller system includes a second blade coupled to the coupling module, the second blade being configured to rotate about a second blade axis, the second blade axis being substantially horizontal. The second blade progresses through a second continuous, repeating sequence of second blade orientations, the second continuous, repeating sequence of second blade orientations including a second substantially vertical orientation and a second substantially horizontal orientation. The second substantially vertical orientation presents a maximal cross-section to the wind stream and the second substantially horizontal orientation presents a minimal cross-section to the wind stream. The second blade revolves around the coupling module in response to the wind stream, based on the second blade orientation, so as to impart rotational energy to the coupling module. The coupling module further aligns the second continuous, repeating sequence of blade orientations so that the second substantially vertical orientation occurs at a predetermined angle to the wind direction. In one embodiment, the second blade axis and the first blade axis are substantially contiguous.

In another general aspect of the invention, a method for capturing wind energy includes disposing a vertical propeller windmill within a wind stream, the wind stream having a wind direction. The vertical propeller windmill comprises a coupling coupled to a drive shaft so as to impart rotational energy from the coupling module to the drive shaft. The drive shaft rotates about a substantially vertical main axis. A first blade couples to the coupling module and rotates about a substantially horizontal first blade axis. The first blade progresses through a first continuous, repeating sequence of first blade orientations, which include a first substantially vertical orientation and a first substantially horizontal orientation. The first substantially vertical orientation presents a maximal cross-section to the wind stream. The first substantially horizontal orientation presents a minimal cross-section to the wind stream. The first blade revolves around the coupling module in response to the wind stream, based on the first blade orientation, so as to impart rotational energy to the coupling module. The coupling module aligns the first continuous, repeating sequence of blade orientations so that the first substantially vertical orientation occurs at a predetermined angle to the wind direction. The method also includes capturing the rotational energy of the drive shaft.

In one embodiment, the coupling module comprises a gear box, the gear box being configured to change the alignment of the first continuous, repeating sequence of blade orientations. In one embodiment, the coupling module comprises a gear box, the gear box being configured to change the alignment of the first continuous, repeating sequence of blade orientations, based on the wind direction.

In one embodiment, the coupling module comprises a sun gear and the first blade comprises a planet gear coupled to the sun gear. In one embodiment, the coupling module comprises a worm gear, the worm gear being configured to change the alignment of the first continuous, repeating sequence of blade orientations. In one embodiment, the coupling module comprises a frame coupled to the drive shaft and a gear box coupled to the frame and the first blade. In one embodiment, the coupling module is configured to change the alignment of the first continuous, repeating sequence of blade orientations based on a desired efficiency.

In one embodiment, the vertical propeller windmill includes a second blade coupled to the coupling module, the second blade configured to rotate about a second blade axis, the second blade axis being substantially horizontal. The second blade progresses through a second continuous, repeating sequence of second blade orientations, the second continuous, repeating sequence of second blade orientations including a second substantially vertical orientation and a second substantially horizontal orientation. The second substantially vertical orientation presents a maximal cross-section to the wind stream and the second substantially horizontal orientation presents a minimal cross-section to the wind stream. The second blade revolves around the coupling module in response to the wind stream, based on the second blade orientation, so as to impart rotational energy to the coupling module. The coupling module aligns the second continuous, repeating sequence of blade orientations so that the second substantially vertical orientation occurs at a predetermined angle to the wind direction. In one embodiment, the method detects a change in the wind direction and changes the alignment of the first continuous, repeating sequence of blade orientations to maintain the predetermined angle to the wind direction.

In another general aspect of the invention, a system for generating electrical energy includes a first drive shaft segment configured to rotate about a main axis in response to applied torque, generating rotational energy. A first vertical propeller module couples to the first drive shaft, and is configured to apply torque to the first drive shaft segment. The first vertical propeller module includes a coupling module coupled to the first drive shaft segment so as to apply torque to the first drive shaft segment. A first blade couples to the coupling module, and is configured to rotate about a substantially horizontal first blade axis. The first blade progresses through a first continuous, repeating sequence of first blade orientations, which include a first substantially vertical orientation and a first substantially horizontal orientation. The first substantially vertical orientation presents a maximal cross-section to a wind stream, the wind stream having a wind direction. The first substantially horizontal orientation presents a minimal cross-section to the wind stream. The first blade revolves around the coupling module in response to the wind stream, based on the first blade orientation, so as to impart rotational energy to the coupling module. The coupling module aligns the first continuous, repeating sequence of blade orientations so that the first substantially vertical orientation occurs at a predetermined angle to the wind direction. A generator couples to the first drive shaft segment. The generator converts rotational energy of the first drive shaft segment into electrical energy.

In one embodiment, the system includes a second drive shaft segment coupled to the first vertical propeller module, the second drive shaft segment configured to rotate about the main axis in response to applied torque, generating rotational energy. A second vertical propeller module couples to the second drive shaft, the second vertical propeller module configured to apply torque to the second drive shaft segment. The second vertical propeller module includes a coupling module configured to couple to the second drive shaft segment so as to apply torque to the second drive shaft segment. A first blade couples to the coupling module, the first blade being configured to rotate about a first blade axis, the first blade axis being substantially horizontal. The first blade progresses through a first continuous, repeating sequence of first blade orientations, the first continuous, repeating sequence of first blade orientations including a first substantially vertical orientation and a first substantially horizontal orientation. The first substantially vertical orientation presents a maximal cross-section to the wind stream and the first substantially horizontal orientation presents a minimal cross-section to the wind stream. The first blade revolves around the coupling module in response to the wind stream, based on the first blade orientation, so as to impart rotational energy to the coupling module. The coupling module aligns the first continuous, repeating sequence of blade orientations so that the first substantially vertical orientation occurs at a predetermined angle to the wind direction.

In one embodiment, the coupling module detects a change in the wind direction and changes the alignment of the first continuous, repeating sequence of blade orientations of the first vertical propeller module to maintain the predetermined angle to the wind direction. In one embodiment, the coupling module of the second vertical propeller module detects a change in the wind direction and changes the alignment of the first continuous, repeating sequence of blade orientations of the second vertical propeller module to maintain the predetermined angle to the wind direction. In one embodiment, the coupling module of the first vertical propeller module is configured to determine the efficiency of the vertical propeller windmill and to change the alignment of the first continuous, repeating sequence of blade orientations to achieve a predetermined efficiency.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a high-level block diagram showing a fluid energy capture system, which can be implemented in accordance with a preferred embodiment;

FIG. 2 illustrates an exemplary fluid energy capture system in additional detail, which can be implemented in accordance with a preferred embodiment;

FIGS. 3A and 3B illustrate an exemplary fluid energy capture wing configuration, which can be implemented in accordance with a preferred embodiment;

FIGS. 4A and 4B illustrate technical details of an exemplary fluid energy capture system, which can be implemented in accordance with a preferred embodiment;

FIG. 5 illustrates an exemplary fluid energy capture system in additional detail, which can be implemented in accordance with a preferred embodiment;

FIG. 6 is a flow diagram illustrating an exemplary fluid energy capture method, which can be implemented in accordance with a preferred embodiment;

FIG. 7 illustrates a high-level block diagram showing a fluid energy capture system, which can be implemented in accordance with a preferred embodiment; and

FIG. 8 is a flow diagram illustrating an exemplary fluid energy capture method, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope of the invention. While numerous specific details are set forth to provide a thorough understanding of the present invention, those skilled in the art will appreciate that the present invention may be practiced without such specific details. In other instances, well-known elements have been illustrated in schematic or block diagram form in order not to obscure the present invention in unnecessary detail. Additionally, many modifications and variations will be apparent to one of ordinary skill in the relevant arts.

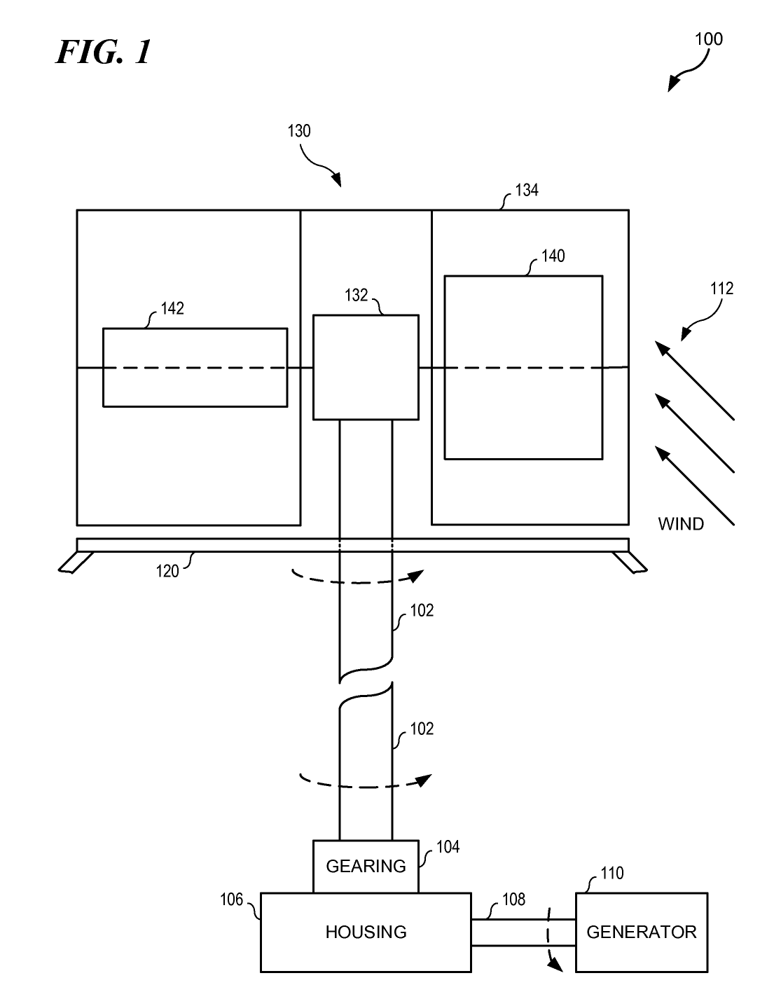

Referring now to the drawings, FIG. 1 illustrates a high-level block diagram of a fluid energy capture system 100. As shown, system 100 includes a main shaft 102 coupled to a fluid energy capture module 130, supported on a tower structure 120. Generally, tower structure 120 is a support structure able to elevate and support the components of the disclosed embodiments as described herein. One skilled in the art will understand that a wide array of suitable tower structures and support techniques are available. For the most part, details of such tower structures and support techniques have been omitted in order to focus on the unique embodiments disclosed herein.

As described in more detail below, module 130 generally includes a frame 134 and a coupling module 132, to which couple one or more wings 140 and 142. Generally, wings 140 and 142 interact with fluid flow around module 120 to impart rotational energy to shaft 102, indicated by the directional arrows. Specifically, in one embodiment, wings 140 and 142 interact with wind having a direction indicated by arrows 112, to impart rotational energy to coupling module 132, which transfers received rotational energy to shaft 102. In one embodiment, shaft 102 is an otherwise conventional main shaft, such as a windmill drive shaft, for example.

In the illustrated embodiment, system 100 includes additional standard components configured to control system 100 and to convert rotational energy imparted to shaft 102 into usable electrical energy. For example, shaft 102 couples to a gearing 104. In one embodiment, gearing 104 includes a brake configured to apply friction or other mechanism to reduce the rotational speed of shaft 102. In one embodiment, gearing 104 is configured to translate the rotational energy of shaft 102 into rotational energy applied to a generator shaft, such as that coupled to a generator shaft 108, for example. Generator shaft 108 is an otherwise conventional generator shaft, configured to couple to a generator, such as generator 110, for example. Generator 110 is an otherwise conventional generator, and is able to receive rotational energy and to convert received rotational energy into electrical energy for delivery to a load.

In the illustrated embodiment, system 100 also includes a housing 106. In one embodiment, housing 106 includes a control module configured to monitor various operating indicia, such as operating conditions, generator 110 speed, shaft 102 speed, wind speed and direction, and other suitable indicia. In one embodiment, housing 106 is also configured to employ received operating indicia to manipulate control mechanisms on one or more of the system 100 components to achieve operational goals, as described in more detail below.

Generally, system 100 can be configured for operation in a variety of fluid flow environments, such as wind and water, for example. For ease of discussion, the embodiments described herein are described primarily with respect to capturing energy from wind. One skilled in the art will understand that the disclosed embodiments can be converted to suitable water energy capture embodiments with minor modifications. For example, the orientation of wing 140 with respect to the horizontal in a wind configuration is usually configured such that wing 140 does not extend significantly higher than shaft 102. In a water energy capture embodiment, a fully deployed wing 140 can be configured to operate at a depth greater than that of the terminus of shaft 102.

Certain elements of the disclosed embodiments are common to both wind energy and water energy capture systems. A partial list includes drive shaft 102, pairs of wings 140 and 142, frame 134 and coupling module 132. Generally, each element works within system 100 to enable and/or assist system 100 to capture fluid energy and convert it to a useful form.

Generally, certain of the disclosed embodiments provide a vertical propeller that is contained in a framework. The framework, in some embodiments, is rigid and capable of transferring the torque created by the propeller blades to the vertical shaft of the windmill as the frame of the propeller system rotates. As described in more detail below, the framework eliminates the need for the vertical shaft to pass through the propeller and its blade/wing orientation gear system. As such, in some multiple propeller windmill embodiments, the frameworks of the propeller system connect the two ends of interrupted windmill shafts, which attach to the framework top and bottom at each of the interrupted windmill shaft ends.

Additionally, in some embodiments, as described in more detail below, the propeller blades (sometimes referred to herein as “wings”) each mount to their own rotatable horizontal shaft. For example, in one embodiment, one end of each wing horizontal shaft attaches to a gearbox. In some embodiments, the gearbox couples the wing horizontal shafts to a central and common sun gear, which surrounds the vertical shaft of the windmill, but is not fixed to the windmill vertical shaft, as described in more detail below.

In one embodiment, described in more detail below, the central sun gear can be rotated to change its orientation to the vertical shaft of the windmill. Thus, in embodiments where the sun gear controls the orientation of the wings, system 100 can be configured to reorient the horizontal rotation of the wings, to match wind direction for example. In one embodiment, described in more detail below, a gear motor rotates the sun gear to bring the wings into the desired orientation with the wind direction. Thus, as described in more detail below, the disclosed embodiments provide a flexible vertical propeller system, with wings that dynamically present a variable cross-section to a fluid flow, and a framework able to reorient based on the prevailing wind direction. Together, these and other features of the disclosed embodiment, described in more detail below, provide numerous advantages over previous systems and methods.

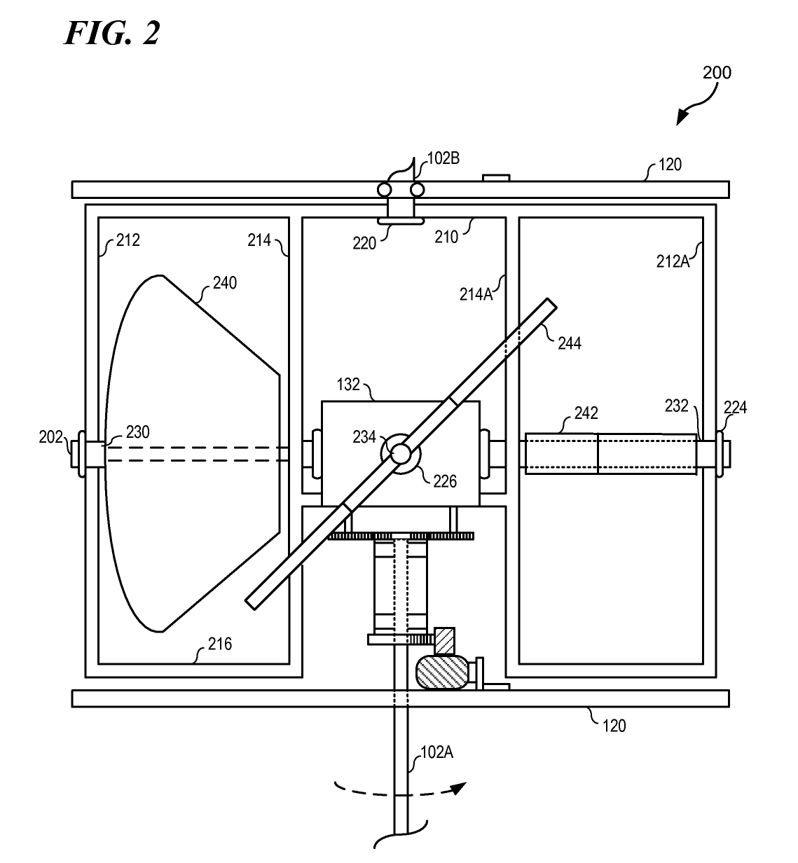

For example, FIG. 2 illustrates an exemplary fluid capture system 200 in accordance with one embodiment. Specifically, system 200 includes a frame top 210 coupled to a main shaft 102B. In the illustrated embodiment, main shaft 102B is a portion of a main shaft 102. As described in more detail below, certain of the disclosed embodiments allow for segmentation of the main shaft, which provides certain technical advantages over earlier approaches. Additionally, in the illustrated embodiment, flange 220 couples frame top 210 to main shaft 102B. One skilled in the art will understand that there are a variety of suitable options to couple frame top 210 to main shaft 102B. Generally, as described in more detail below, certain components couple to frame top 210, imparting rotational energy and/or torque to frame top 210, and thus to shaft 1026.

For example, in the illustrated embodiment, a plurality of frame outer sidewalls 212 and a plurality of corresponding frame inner sidewalls 214 also couple to frame top 210. Generally, a blade (sometimes referred to as a “wing”) and blade shaft (sometimes referred to as a “wing shaft”) couple to each of a pair of frame outer sidewall 212 and frame inner sidewall 213. For example, in the illustrated embodiment, blade shaft 230 couples to frame outer sidewall 212 and frame inner sidewall 214. Similarly, in the illustrated embodiment, blade shaft 232 couples to frame outer sidewall 212A and frame inner sidewall 214A.

In the illustrated embodiment, a bearing 222 couples blade shaft 230 to frame outer sidewall 212 and supports blade shaft 230 so that blade shaft 230 is able to rotate about the blade shaft 230 axis. In the illustrated embodiment, the blade shaft 230 axis is substantially horizontal. As illustrated, blade shaft 230 couples to and supports blade 240 so that blade 240 can rotate about the axis of blade shaft 230. As described in more detail below, the rotation of blade 240 about the axis of blade shaft 230 changes the surface area of blade 240 that blade 240 presents to a fluid flow. The illustrated embodiment shows blade 240 in a maximal surface area presentation.

Generally, in the illustrated embodiment, each blade of system 200 is similarly configured. For example, in the illustrated embodiment, a bearing 224 couples blade shaft 232 to frame outer sidewall 212a and supports blade shaft 232 so that blade shaft 232 is able to rotate about the blade shaft 232 axis. In the illustrated embodiment, the blade shaft 232 axis is substantially horizontal. As illustrated, blade shaft 232 couples to and supports blade 242 so that blade 242 can rotate about the blade shaft 232 axis. As described in more detail below, the rotation of blade 242 about the axis of blade shaft 232 changes the surface area of blade 242 that blade 242 presents to a fluid flow. The illustrated embodiment shows blade 242 in a minimal surface area presentation.

Similarly, in the illustrated embodiment, a bearing 226 couples blade shaft 234 to a frame outer sidewall (not shown) and supports blade shaft 234 so that blade shaft 234 is able to rotate about the blade shaft 234 axis. In the illustrated embodiment, the blade shaft 234 axis is substantially horizontal. As illustrated, blade shaft 234 couples to and supports blade 244 so that blade 244 can rotate about the blade shaft 234 axis. As described in more detail below, the rotation of blade 244 about the axis of blade shaft 234 changes the surface area of blade 244 that blade 244 presents to a fluid flow. The illustrated embodiment shows blade 244 in a presentation midway between a maximal and a minimal surface area presentation.

In one embodiment, blade 240 (and other blades of system 200) is made of any appropriate materials and with any appropriate construction designs that give it sufficient strength and flexibility to withstand the forces expected to be exerted on it. For example, in one embodiment, blade 240 is made of aluminum, using common aircraft construction methods, which makes the wing relatively light and strong, and therefore proves to be a very satisfactory method of construction. Generally, blade 240 is configured to be disposed within a fluid flow (here, an airstream) and to present at least two cross-sectional areas to the fluid flow, a maximal cross-section and a minimal cross-section, as described in more detail below. In one embodiment, blade 240 is designed to bend, bow, or otherwise deflect at wind speeds higher than a predetermined maximum, so as to protect the wing from damage caused by high winds.

In the illustrated embodiment, system 200 includes four blades, of which FIG. 2 shows only blade 240, blade 242, and blade 244. In one embodiment, system 200 includes only two blades. In an alternate embodiment, system 200 includes six blades. In one embodiment, system 200 includes an even number of blades, each blade paired with an opposite companion. In one embodiment, system 200 includes an odd number of blades, each blade disposed at an equivalent angular displacement.

As described above, the blades of system 200 are adapted to be disposed in a fluid flow. The action of a fluid flow on the surface area of the blades causes the blades to revolve about the axis of the main shaft. Generally, the revolution of the blades about the main shaft axis imparts rotational energy to the coupling module 132. As described in more detail below, coupling module 132 transfers received rotational energy as torque applied to the main shaft 102A and 102B.

As described in more detail below, as the blades revolve around the main shaft axis, the blades assume certain positions relative to the fluid flow, sometimes referred to herein as “attitudes” or “orientations.” Additionally, in some embodiments, the blades couple to coupling module 132 so as to facilitate transition from one operational attitudes to another operational attitude. For example, in one embodiment, the rotation of the blades about their respective blade shaft axes proceeds through a continuous, repeating sequence of blade orientations, as described in more detail below. In one embodiment, the continuous, repeating sequence of blade orientations includes a starting position. As described in more detail below, in some embodiments, coupling module 132 is adapted to orient the blade shafts so that the starting position coincides with a particular location of the blade orbit, relative to the prevailing wind.

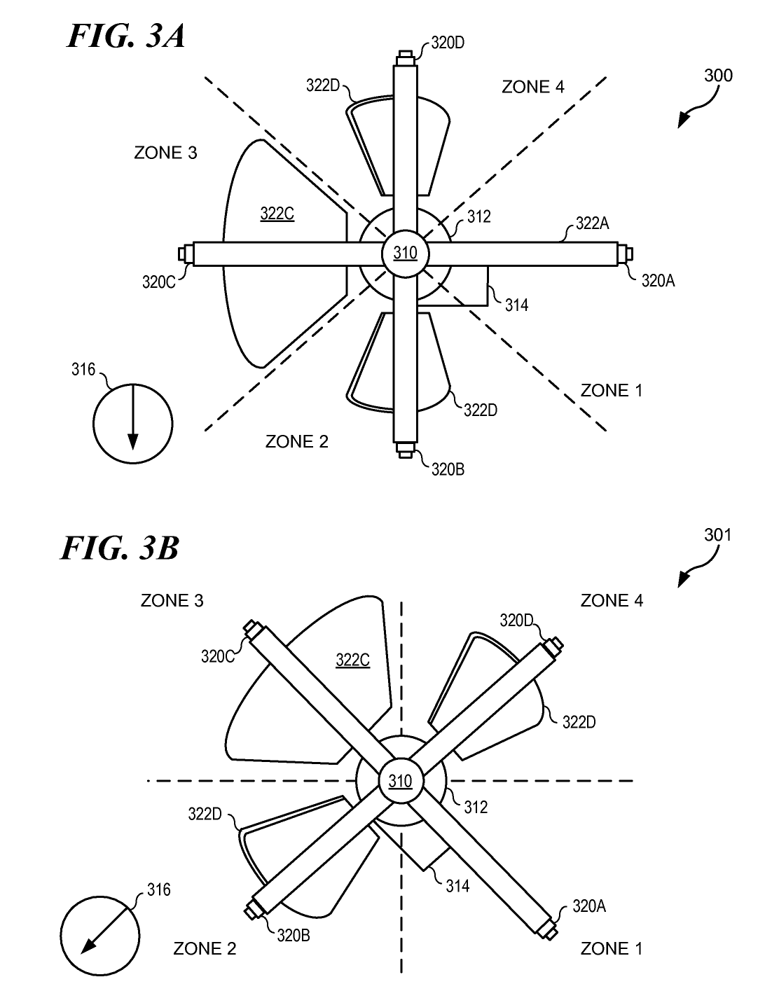

For example, FIGS. 3A and 3B illustrate a top-down view of an exemplary fluid energy capture wing configuration, in accordance with one embodiment. As described above, in one embodiment, the rotation of the blades about their respective blade shaft axes proceeds through a continuous, repeating sequence of blade orientations. So configured, the blades transition through and between a minimal cross-section (“flying”) attitude and a maximal cross-section (“power”) attitude as the blade proceeds through the sequence of blade orientations.

In the illustrated embodiments of FIGS. 3A and 3B, a main shaft 310 couples to a coupling module 312. Similarly, in the illustrated embodiments, blade shafts 320A, 320B, 320C, and 320D couple to the coupling module 312. Similarly, in the illustrated embodiments, blades 322A, 322B, 322C, and 322D couple to blade shafts 320A, 320B, 320C, and 320D, respectively. As illustrated, 322A, 322B, 322C, and 322D are shown in mid-rotation, in different operational attitudes, as the blades revolve around main shaft 310. In the illustrated embodiment of FIG. 3A, for example, blade 322C is in a “flying” attitude, presenting a reduced cross-section to the wind, which greatly reduces counter-torque (or drag) applied to shaft 310, as described in more detail below. Similarly, blade 322A is in a “power” attitude, presenting a maximal cross-section to the wind, the better to capture the energy in the wind, greatly increasing the torque applied to shaft 310. Generally, as used herein, the power attitude presents a larger cross-section to the wind than the flying attitude.

In one embodiment, each blade is configured to rotate about its blade axis independently from other blades. In one embodiment, the coupling module maintains a correlation between pairs of blades. For example, in one embodiment, coupling module 312 fixes wing 322A and wing 322B in a stable orientation with respect to each other. In operation, as each wing revolves around the main shaft axis, the wing rotates about its blade shaft axis through a continuous sequence of orientations, from the flying attitude to the power attitude and back again, as described in more detail below.

As illustrated in FIGS. 3A and 3B, in one embodiment, the orientation of the sequence of attitudes can be configured based in part on the prevailing wind conditions. For example, FIGS. 3A and 3B illustrate a high-level block diagram showing a wind energy capture system 300 and 301 partitioned into four operational zones. In the illustrated embodiment, systems 300 and 301 are disposed in an airstream generally flowing as indicated by arrow 316.

Generally, systems 300 and 301 are partitioned into four segments (also known as “quadrants” and/or “zones”). Generally, in the first segment, Zone 1, the blade is transitioning from a mostly vertical attitude, through the power attitude, into a mostly vertical attitude before a transition to the flying attitude. In one embodiment, in Zone 1, the blade is moving entirely with the wind. In one embodiment, Zone 1 is the “downwind zone.”

Generally, in the next segment, Zone 2, the blade is in transition from a mostly vertical attitude to a mostly horizontal attitude, as the blade passes through a crosswind behind the main shaft. In one embodiment, in Zone 2, the blade is moving across the direction of the wind. In one embodiment, Zone 2 is the “high-to-low torque transitional zone.”

Generally, in the next segment, Zone 3, the blade is transitioning from a mostly horizontal attitude, through the flying attitude, into a mostly horizontal attitude before a transition to the power attitude. In one embodiment, in Zone 3, the blade is moving entirely against the wind. In one embodiment, Zone 3 is the “upwind zone.”

Generally, in the next segment, Zone 4, the blade is in transition from a mostly horizontal attitude to a mostly vertical attitude, as the blade passes through a crosswind in front of the main shaft. In one embodiment, in Zone 4, the blade is moving across the direction of the wind. In one embodiment, Zone 4 is the “low-to-high torque transitional zone.” As described in more detail below, in one embodiment, Zone 1 is called the “primary torque zone”, and Zones 2 and 4 are called “transition zones.” In one embodiment, the transition zones are also secondary torque zones.

Generally, each Zone covers a segment of the blade's path as it revolves around the main shaft. In one embodiment, each Zone is substantially the same size. In one embodiment, the precise borders of each Zone depend on changing environmental factors, including wind speed and direction, small differences between the blades and wind across the blade itself, and other factors. In the illustrated embodiment, the zones are oriented with the wind such that the center of Zone 4 is directly facing the wind. In an alternate embodiment, the zones are oriented as an offset angle 314 from the perpendicular to the wind direction.

In one embodiment, each Zone is configured expressly and, as described above, systems 300 and 301 include control mechanisms to orient each blade according to its Zone location as the blade travels around the main shaft axis. In an alternate embodiment, each Zone arises as a function of the procession of the blades around the drive shaft axis and, as such, each Zone is a descriptive construct and not a mechanical or operational restraint.

In one embodiment, each blade creates its maximum main shaft torque in Zone 1, as the blade travels downwind and presents its maximum cross section to the wind. Similarly, each blade creates a lesser, but still significant main shaft torque in Zone 2, as the blade transitions between Zone 1 and Zone 3 and from maximum positive torque to zero torque. In Zone 3, in some embodiments, each blade creates no positive torque, but significantly reduces counter-torque by transitioning into the flying attitude as it moves upwind. In Zone 4, the blade creates torque roughly equivalent to that created in Zone 2 as it transitions from Zone 3 back to Zone 1. In Zone 4, the blade is transitioning from zero positive torque to maximum positive torque.

As shown in the illustrated four-blade vertical propeller embodiment, each blade revolves around the main shaft axis 45 degrees ahead of its following blade and 45 degrees behind its leading blade. So configured all four blades revolve in a coordinated manner, 45 degrees apart, around the main shaft axis.

For example, in the illustrated embodiment, in one revolution around the main shaft axis, a blade completes one-half of a full rotation about its blade shaft axis. For example, at the beginning of the blade orientation sequence (the zero point), the blade is in a vertical position, which is the maximum wind interaction position for a blade in the disclosed embodiments. As described above, in one embodiment, the centerline of Zone 1 is the point at which the zero point achieves maximum efficiency from the propeller blade/wings.

As the blade moves from Zone 1 to Zone 2, revolving 45 degrees around the main shaft axis, the blade interacts with the wind at a 45-degree angle to vertical. In this position, the blade directs the wind upward over its surface, creating torque in the same rotatable direction on the main shaft axis as in Zone 1, though with less force. This configuration obtains through the first half of Zone 2, as the blade revolves another 45 degrees around the main shaft axis.

In the last half of Zone 2, revolving another 45 degrees around the main shaft axis, the blade rotates about its blade shaft axis toward horizontal. The blade also progressively transitions out of the wind-interaction position as it passes through Zone 2. In one embodiment, the blade is oriented 22 degrees from horizontal as the blade crosses the transition from Zone 2 into Zone 3.

In one embodiment, as the blade passes through the centerline of Zone 3, the blade completes the transition to the minimum wind-interaction position. As described above, the minimum wind-interaction position is a horizontal orientation that allows the blade to revolve upwind without interacting substantially with the wind. Thus, the minimum wind-interaction position imparts only a relatively small back-torque on the propeller rotation.

In one embodiment, as the blade passes from Zone 3 to Zone 4 the blade begins transitioning back to a vertical orientation. At the centerline of Zone 4, the blade is at a 45-degree to vertical, which is halfway to vertical orientation. As described above, at 45 degrees to vertical, the blade begins to redirect wind downward, which creates torque in the desired direction on the vertical propeller as the blade/wing 104 continues through Zone 4. At the border between Zone 4 and Zone 1, each blade/wing is only 22 degrees from vertical and is in the maximum wind-interaction position from this point until it pass through vertical at the Zone 1 centerline, and then 22 degrees past vertical at the border between Zones 1 and 2.

As described above, in one embodiment, Zone 1 is the primary torque zone and Zones 2 and 4 are transition and secondary torque zones. More specifically, in one embodiment, the blades create progressively less positive torque as they cross Zone 2. Similarly, the blades begin transitioning back toward vertical as they enter Zone 4, but do not present a significant blade cross-section to the wind until the blade is oriented approximately 45 degrees to vertical (at the centerline of Zone 4). From the centerline of Zone 4, the blade creates progressively more torque as the blade passes through the last half of Zone 4 into Zone 1.

In one embodiment, Zone 3 is called the “minimum wind-interaction zone,” as the objective is to achieve as little interaction with the wind as possible as the blade travels upwind. In one embodiment, as described above, the system minimizes blade wind interaction by entering Zone 3 at a maximum degree from horizontal of 22 degrees, progressively rotating through horizontal to a maximum of 22 degrees from horizontal as the blade reaches the boundary between Zone 3 and Zone 4.

Thus, in the illustrated embodiment, each Zone covers a portion of the path a blade travels as the blade moves through space around the axis of the main shaft. So configured, the location of a blade with respect to that path can be represented as a phase angle measuring the distance the blade has moved along the path from a predetermined starting location. Further, as described above, the operational attitude of the blade changes as the blade moves through each segment. As such, the phase angle of the blade can be configured to indicate the blade's transition and attitude.

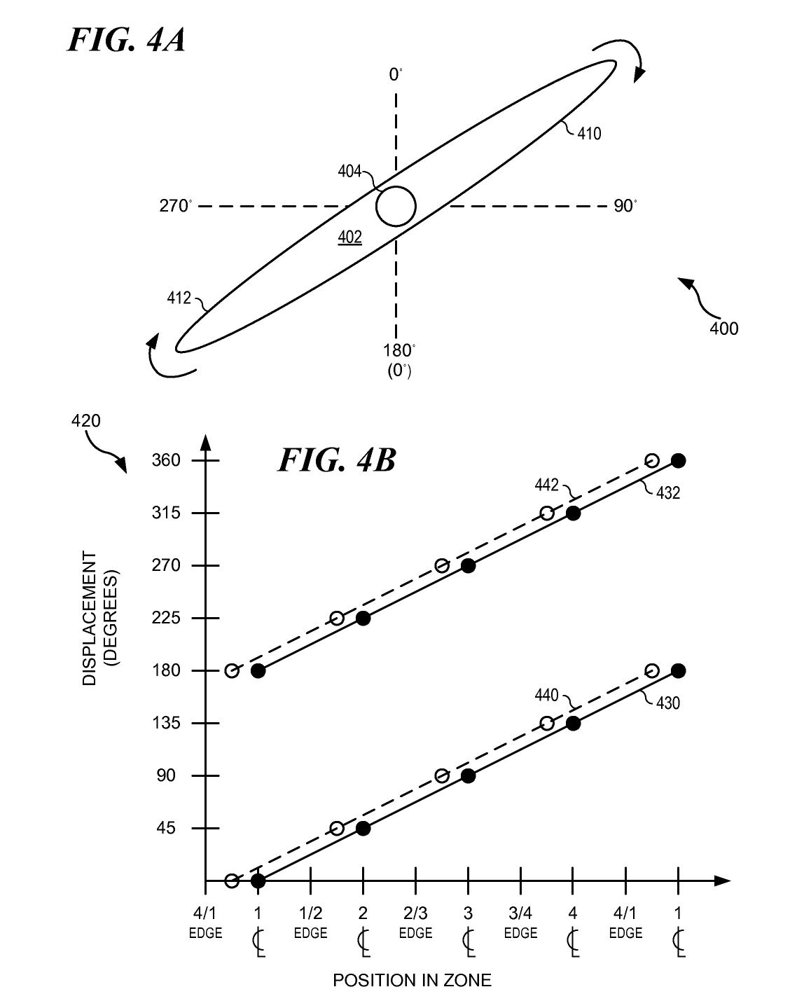

For example, FIG. 4 presents charts 400 and 420 illustrating generalized data relating to a blade and its orientation as the blade rotates about its blade axis and travels (revolves) around the main shaft axis. The data represented by the illustrated curves have been abstracted to illustrate the principles underlying the embodiments disclosed herein and are not based on specific measured data.

In particular, chart 400 illustrates a blade 404 rotating about a blade shaft 404 in the direction of the arrows. In the illustrated embodiment, blade 404 includes two identical, or nearly identical, blade ends 410 and 412. In the illustrated embodiment, the blade attitude, as it rotates about its blade axis, is described in terms of the angle of deflection from the vertical. For ease of illustration, the starting orientation (0 degrees) represents the point of the blade's rotation around the blade axis at which the blade is completely in the power attitude, which is a 0 degree deflection from the vertical (and a 90 degree deflection from the horizontal). As described in more detail below, in one embodiment, this starting orientation is sometimes referred to as the “zero point.”

As shown, each blade end travels 360 degrees around the blade axis 404. As such, when blade end 410 is at 0 degrees, blade end 412 is at 180 degrees. In an embodiment where the blade ends are not nearly identical, for example, what is 180 degrees for blade end 410 is considered 0 degrees for blade end 412. One skilled in the art will understand that the angular nomenclature employed herein is offered to describe the operation and configuration of the disclosed embodiments. As such, these specific degrees are offered only to illustrate the features of the disclosed embodiments, and should not be considered limiting except as expressly recited in the claims.

Chart 420 describes the orientation of the blade, with respect to its blade ends, as the blade travels through the operational Zones in its revolution around the main shaft. Generally, line 430 describes the displacement of blade end 410 through one revolution around the main shaft. Similarly, line 432 describes the displacement of blade end 412 through one revolution around the main shaft. One skilled in the art will understand that, in one embodiment, lines 430 and 432 describe the orientation of blade end 410 during alternating revolutions around the main shaft.

Thus, chart 420 describes, in one embodiment, a continuous, repeating sequence of blade orientations. As described above, in one embodiment, the “starting location” of the continuous, repeating sequence of blade orientations can be configured to coincide with a particular location with respect to the prevailing environmental wind conditions. For example, in one embodiment, the “starting location” or “zero point” is 0 degrees displacement from the vertical. In the illustrated embodiment, graph 420 shows the starting location as disposed at the centerline or midpoint of Zone 1.

As described in more detail below, in some embodiments, it is sometimes advantageous to adjust the zero point to a location other than the centerline of Zone 1. For example, in one embodiment, as described in more detail below, the system adjusts the zero point in response to changing wind conditions and the mechanical state of the main shaft and blade module. For example, one skilled in the art will understand that a blade is at its maximum efficiency (in terms of wind interaction to torque applied to the main shaft) when the zero point is at the centerline of Zone 1. So configured, the vertical blade presents the maximum cross-section to the wind stream, and therefore generates the maximum torque.

However, one skilled in the art will also understand that high wind conditions can damage the blades and other system components, both in the power of the wind itself and in the foreign object debris (FOD) the wind can carry. In one embodiment, the system adjusts the zero point to reduce the blade efficiency so that the full force of the wind stream does not over-torque the system components. For example, in the illustrated embodiment, the system shifts the zero point downwind by about 22 degrees, as shown by lines 440 and 442.

So configured, the vertical orientation of the blade occurs between the centerline of Zone 1 and the edge between Zones 1 and 2. In one embodiment, moving the zero point downwind by 22 degrees from the Zone 1 centerline causes the blade to operate less efficiently in Zones 1, 2, and 4 and to experience more wind interaction in Zone 3. One skilled in the art will understand that this transition reduces the efficiency and energy capture of the blades. More specifically, in one embodiment, as described in more detail below, the reduction in efficiency allows the blade (and blade module) to continue to operate at the same torque and rpm, even in higher-than-desired wind speeds.

In one embodiment, as described in more detail below, the zero point can be adjusted until the blades are in a self-opposing orientation. Generally, in one embodiment, the self-opposing orientation is such that the effect of the blade interaction with the wind of the downwind blade (in Zone 1) provides roughly equivalent counter torque to the effect of the upwind blade wind interaction (in Zone 3). As such, the blades operate counter to each other, restricting the blade module from rotation in either direction. One skilled in the art will understand that the self-opposing orientation can, in one embodiment, obtain indefinitely despite continued increases in wind speed.

In one embodiment, this self-opposing orientation occurs when the zero point is at or near the centerline of Zone 2. In an alternate embodiment, this self-opposing orientation occurs when the zero point is at or near the centerline of Zone 4. In one embodiment, this self-opposing orientation occurs when the blades settle such that the blade axes are situated at the zone boundaries and the blades are oriented approximately 45 degrees off vertical. One skill in the art will understand that there are several other suitable self-opposing orientations, and that adjustments in the zero point can cause the blades to settle in a self-opposing orientation that does not include a blade in the substantially horizontal or substantially vertical orientation.

Additionally, as described in more detail below, the disclosed embodiments can be configured to adjust the zero point in order to improve the efficiency of a blade/blade module. For example, in one embodiment, moving the zero point toward the Zone 1 centerline generally causes the blade to operate more efficiently. More specifically, in one embodiment, as described in more detail below, the improvement in efficiency allows the blade (and blade module) to continue to operate at the same torque and rpm, even in lower-than-desired wind speeds.

Thus, the disclosed embodiments can be configured to adjust the zero point, which, as described in more detail below, provides improved control and efficiency of the vertical propeller system. So configured, the system can match the blade module's efficiency to the current local wind speed so that generation need not be interrupted in high-wind weather, and can yield improved generation in normal- and low-wind weather. So configured, blade 402 presents an optimal orientation to the wind, in a wide variety of operating conditions as blade 402 revolves around the main shaft, as described above.

Additionally, as described above, in some embodiments, control mechanisms to provide torque transfer and zero point adjustment can be provided in a variety of useful configurations. For example, in one embodiment, the gear box 132 of FIG. 2 includes the control mechanisms. In one embodiment, the control mechanisms include a sun gear and a plurality of planet gears, as described in more detail below.

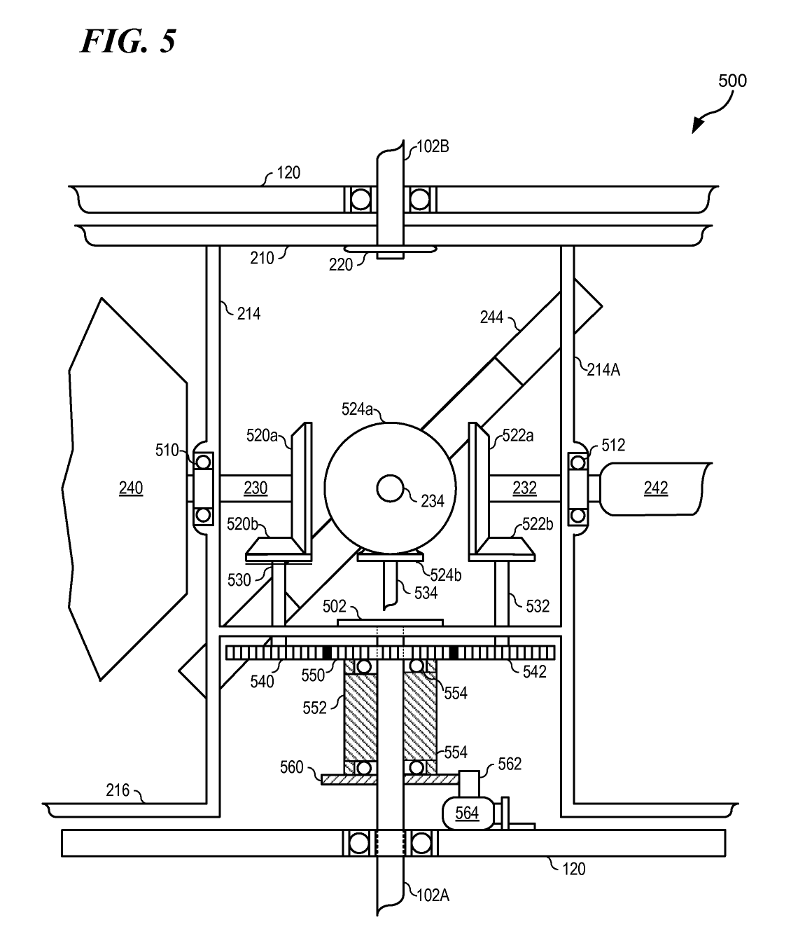

For example, FIG. 5 illustrates a block diagram of a wind generation system 500 in accordance with one embodiment. Generally, system 500 is configured in a similar manner as system 200 of FIG. 2, modified as described below. Very broadly, system 500 captures wind energy as the blades interact with the wind stream, which moves the blades. The blade motion produces torque that is applied to the main shaft. For example, in the illustrated embodiment, system 500 includes blades 240, 242, and 244. In the illustrated embodiment, system 500 also includes a fourth blade and associated gearing, which has been omitted in order to more clearly depict the three illustrated blades.

As described above, blades 240, 242, and 244 couple to a frame 210. In one embodiment, frame 210 and the components that attach to frame 210 (e.g., blades 240, 242, 244, etc.) are collectively referred to as a “blade module.” In the illustrated embodiment, frame 210 couples to main shafts 102A and 102B via otherwise conventional flange 502 and flange 220, respectively. In an alternate embodiment, frame 210 couples to main shaft 102A or main shaft 102B, but not both. As described above, a support structure 120 elevates and supports main shafts 102A and 102B and frame 210.

In the illustrated embodiment, blade shaft 230 couples to frame inner sidewall 214 of frame 210 through an otherwise conventional bearing 510. Similarly, blade shaft 232 couples to frame inner sidewall 214a of frame 210 through an otherwise conventional bearing 512. So configured, wind interaction with blades 240 and 242 generates torque applied to the axis of main shafts 102A and 102B, which torque is transferred to blade shafts 230 and 232. The torque transferred to blade shafts 230 and 232 transfers to frame 210, and thence to main shafts 102A and 102B.

As described above, the disclosed embodiments include control mechanisms configured to adjust the zero point of the blades. In the illustrated embodiment, each blade shaft couples to a planet gear (through beveled gears), and each planet gear couples to and revolves around a sun gear that is fixed to the stationary support structure 120. Specifically, blade shaft 230 couples to an otherwise conventional vertical bevel gear 520a, which couples to an otherwise conventional horizontal bevel gear 520b. Similarly, blade shaft 232 couples to an otherwise conventional vertical bevel gear 522a, which couples to an otherwise conventional horizontal bevel gear 522b. Similarly, blade shaft 234 couples to an otherwise conventional vertical bevel gear 524a, which couples to an otherwise conventional horizontal bevel gear 524b. In one embodiment, the horizontal bevel gears and vertical bevel gears are configured with a 2-to-1 ratio, in which a horizontal bevel gear rotates twice for every rotation of its respective vertical bevel gear.

In the illustrated embodiment, each horizontal bevel gear couples to a planet gear shaft. Specifically, in the illustrated embodiment, horizontal bevel gear 520b couples to an otherwise conventional planet gear shaft 530. Similarly, horizontal bevel gear 522b couples to an otherwise conventional planet gear shaft 532. Similarly, horizontal bevel gear 524b couples to an otherwise conventional planet gear shaft 534.

In the illustrated embodiment, each planet gear shaft couples to a planet gear. Specifically, in the illustrated embodiment, planet gear shaft 530 couples to an otherwise conventional planet gear 540. Similarly, planet gear shaft 532 couples to an otherwise conventional planet gear 542. Generally, each planet gear couples to and revolves around a sun gear. In the illustrated embodiment, planet gears 540 and 542 couple to and revolve around an otherwise conventional sun gear 550.

As described above, the rotation of the blades around the main shaft axis imparts torque to frame 210. Additionally, as frame 210 revolves around the main shaft axis (with main shafts 102A and 102B), frame 210 also rotates, which moves the planet gears in an orbit around sun gear 550. In the illustrated embodiment, as the planet gears revolve around sun gear 550, the planet gears rotate, which causes their associated blades to rotate about their blade axes.

As such, the blades rotate about their blade axes as they revolve around the main shaft axis. As described above, the blade rotation changes how the surface area of the blades interacts with the wind stream, in a sequence of continuous, repeating blade orientations. As described above, the sequence of continuous, repeating blade orientations includes a “zero point.” As described in more detail below, in the illustrated embodiment, sun gear 550 can be configured to adjust the zero point.

Specifically, in the illustrated embodiment, sun gear 550 is fixed in a stationary position relative to support structure 120, which also fixes the zero point for each blade in a particular location in the blades' orbits around the main shaft axis. In the illustrated embodiment, sun gear 550 couples to a hollow shaft 552. In the illustrated embodiment, main shaft 102A passes through hollow shaft 522, which couples to main shaft 102A by otherwise conventional bearings 554 that allow main shaft 102A to rotate within hollow shaft 552.

In the illustrated embodiment, hollow shaft 552 couples to an otherwise conventional worm gear interface-gear 560, through which main shaft 102A passes. In the illustrated embodiment, worm gear interface-gear 560 couples to worm gear 562. Similarly, in the illustrated embodiment, worm gear 562 couples to worm gear motor 564. Generally, worm gear motor 564 is configured to cause worm gear 562 to rotate, which causes worm gear interface-gear 560 to rotate. As worm gear interface-gear 560 rotates, so does sun gear 550.

So configured, system 500 can rotate sun gear 550. As described above, the action of the planet gears causes the blades to rotate as the blades revolve about the main shaft axis. In the illustrated embodiment, rotating sun gear 550 rotates the planet gears in place, which changes the zero point for each blade. As such, in the illustrated embodiment, control mechanism configured to operate worm gear motor 564 can adjust the zero point for each blade, simultaneously, without requiring extensive modification of the blade module.

As described in more detail below, control systems for worm gear motor 564 can include a variety of optimization features. For example, in one embodiment, a wind-direction, wind-speed sensing system determines the orientation of the blade module to the wind stream and the degree of efficiency of the blades based on the orientation to wind. In one embodiment, as described in more detail below, the control systems use the efficiency and orientation to adjust the torque output of the blade module and therefore the energy capture output of the system as a whole.

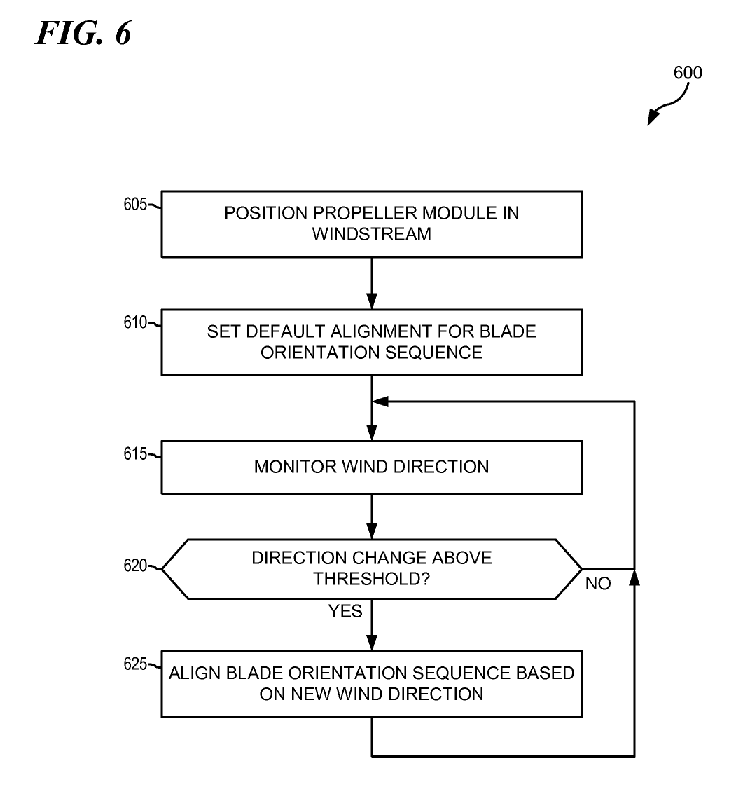

For example, FIG. 6 illustrated a flow diagram 600 describing a fluid energy capture method in accordance with one embodiment. The process begins at block 605, wherein the blade module (sometimes referred to as a “propeller module”) is positioned within a wind stream. Next, as indicated at block 610, the user sets the default alignment for the blade orientation sequence (i.e., the “zero point”). In one embodiment, the default zero point is perpendicular and downwind to the average wind direction for the environment in which the blade module is disposed.

Next, as indicated at block 615, the system monitors the wind direction. Next as indicated at decisional block 620, the system determines whether the wind direction has changed beyond a predetermined threshold. In one embodiment, the predetermined threshold is 5 degrees. If at decisional block 620, the wind direction has not changed beyond a predetermined threshold, the process continues along the NO branch, returning to block 615, described above.

If at decisional block 620, the wind direction has changed beyond a predetermined threshold, the process continues along the YES branch to block 625. As indicated at block 625, the system aligns the blade orientation sequence based on the new wind direction. As described above, in one embodiment, the system adjusts the zero point based on the new wind direction. In one embodiment, the system adjusts the zero point based on the new wind direction and the desired efficiency and/or output of the blade module.

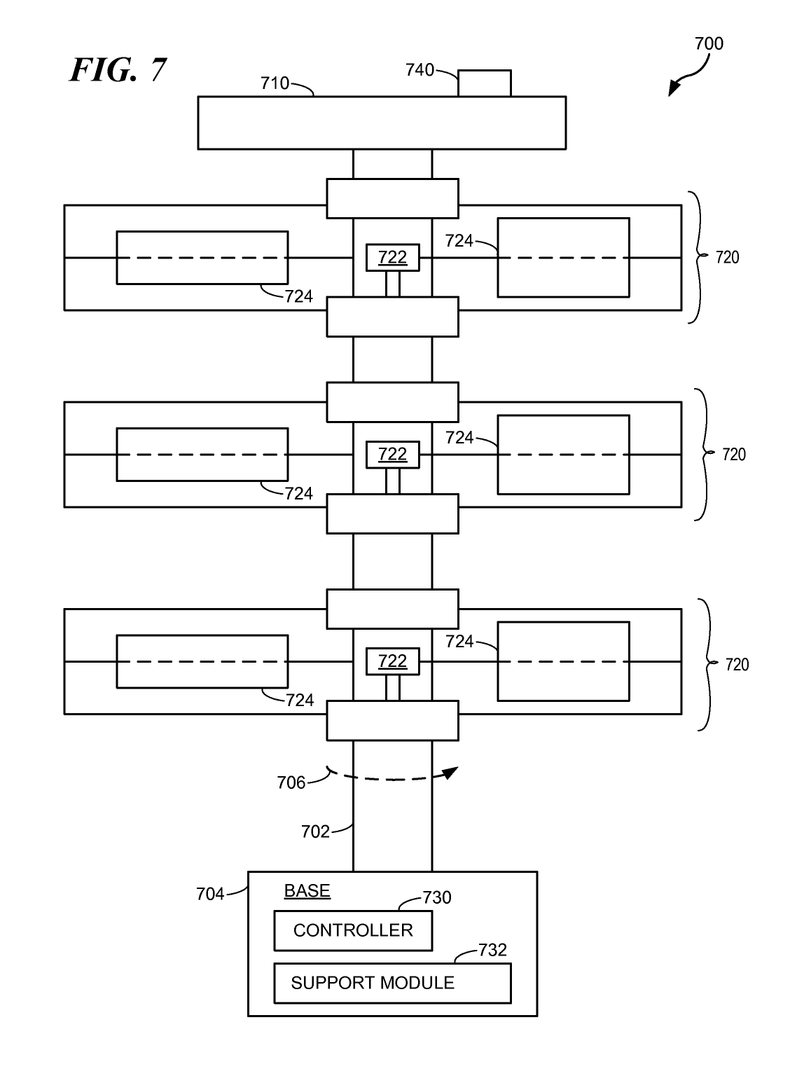

Thus, the disclosed embodiments can be configured to reorient the blade modules so as to maintain a particular orientation with respect to a wind stream. So configured, the disclosed embodiments provide blade modules with a more stable response and performance than typical systems and methods. Additionally, in one embodiment, multiple blade modules can be engaged to operate in cooperation. For example, FIG. 7 illustrates an exemplary wind energy capture system in accordance with one embodiment.

Specifically, FIG. 7 illustrates a system 700. System 700 includes a main shaft 702, coupled to a base 704, the drive shaft 702 being configured to rotate in the direction of arrow 706. As shown, system 700 includes a main shaft 702 coupled to a plurality of blade modules 720, supported on a tower structure 710. Generally, tower structure 710 is a support structure able to elevate and support the components of the disclosed embodiments as described herein. One skilled in the art will understand that a wide array of suitable tower structures and support techniques are available. For the most part, details of such tower structures and support techniques have been omitted in order to focus on the unique embodiments disclosed herein.

In the illustrated embodiment, system 700 includes blade modules 720. As shown, each blade module 720 includes a coupling modules 722 coupled to two blades 724. In the illustrated embodiment, blades 724 are arranged with blade shafts approximately in the same plane of rotation. In the illustrated embodiment, the blade modules 720 are stacked vertically along main shaft 702, and are spaced so as to prevent interference between the blades of neighboring blade modules and other components of system 700. In the illustrated embodiment, the blade pairs of each blade module 720 are aligned vertically with the blade pairs of a neighboring blade module. In an alternate embodiment, neighboring blade pairs are offset vertically.

In the illustrated embodiment system 700 includes three blade modules 720. In an alternate embodiment, system 700 includes fewer than three blade modules. In an alternate embodiment, system 700 includes more than three blade modules. Generally, in one embodiment, the number of blade modules can be configured based on the expected environmental conditions at the location where system 700 will be used.

In the illustrated embodiment, the blade modules 720 impart torque to main shaft 706, which couples to base 704. In the illustrated embodiment, base 704 includes transmission systems (not shown) for transmitting received rotational energy to a generator and control systems configured to control the operation of system 700. For example, in the illustrated embodiment, base 704 includes controller 730 and support module 732. Generally, support module 732 is configured to provide support functions to base 704 and controller 730. One skilled in the art will understand that support functions can include internet connectivity, wireless communication setup and operation, reporting, and other suitable functions.

Generally, controller 730 is configured to receive information from sensors and other input devices and to use control signals to control system 700 based on received information. For example, in the illustrated embodiment, system 700 includes a sensor 740 coupled to tower structure 710. Generally, sensor 740 is an otherwise conventional sensor, configured to measure and report various environmental conditions such as wind speed, wind direction, humidity, pressure, and other suitable conditions. In one embodiment, each module 720 also includes a sensor (not shown).

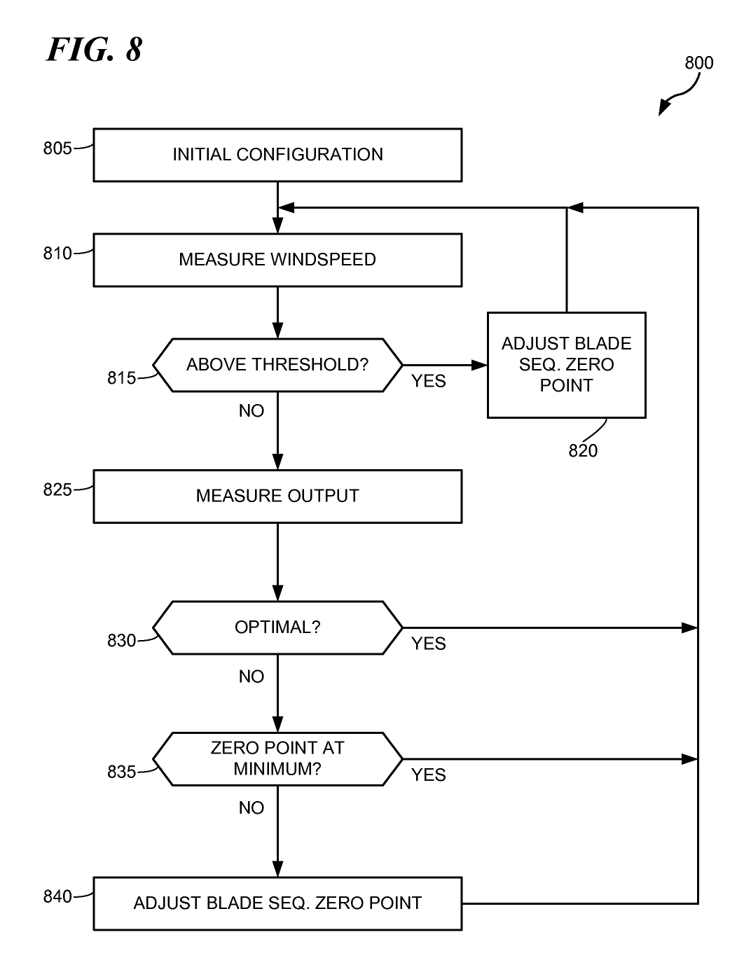

In the illustrated embodiment, controller 730 receives information from sensor 740 and issues commands to the blade modules 720 based on the received information. For example, in one embodiment, controller 730 is configured to control a worm gear motor to adjust the zero point of the blades of one or more blade modules 720. A particular embodiment is described with respect to FIG. 8, below.

The embodiments disclosed herein can thus be configured to capture fluid energy from a fluid flow, and convert that captured energy into rotational energy of a main (drive) shaft. Additionally, as described above, the disclosed embodiments can be configured to operate efficiently in a wider range of environmental conditions than common systems. For example, FIG. 8 depicts a flow diagram 800 illustrating an exemplary method, which can be configured in accordance with one embodiment.

The process begins at block 805, wherein a wind capture system, such as system 100 of FIG. 1, for example, is in an initial configuration. In one embodiment, the initial configuration is a resting state. In an alternate embodiment, the initial configuration is an operational state arising after a warm-up period of operation.

Next, as indicated at block 810, the system measures the wind speed near the rotating wing pair. For example, in one embodiment, sensor 740 of FIG. 7 measures the wind speed module 720. Next, as indicated at decisional block 815, the system, such as controller 730 of FIG. 7, for example, determines whether the wind speed is above a predetermined threshold. In one embodiment, the predetermined threshold is the lowest wind speed above which the blades would likely suffer damage from continued operation as currently configured. In one embodiment, the predetermined threshold is a fixed threshold. In an alternate embodiment, the predetermined threshold is a function of the wind speed and the offset of the zero point of the continuous sequence of blade orientations.

If at decisional block 815 the system determines that the wind speed is above the predetermined threshold, the process continues along the YES branch to block 820. As indicated at block 820, the system adjusts the zero point, as described above. In one embodiment, the system adjusts the zero point so that the effect of wind forces on the blade module 720 restricts revolution of the blades to zero or nearly zero. In an alternate embodiment, the system adjusts the zero point by a predetermined amount. In one embodiment, the predetermined amount is 5 degrees, as measured from the main shaft axis, between the present location of the zero point and the target position of the zero point. The process returns to block 810.

If at decisional block 815 the system determines that the wind speed is not above the predetermined threshold, the process continues along the NO branch to block 825. As indicated at block 825, the system measures the system output. In one embodiment, the system output is a measure of the revolutions per minute (rpm) of the main shaft. In an alternate embodiment, the system output is a measure of the rpm of a generator shaft coupled to the gearbox (not shown) of based 704. In an alternate embodiment, the system output is a measure of the electrical power delivered by a generator coupled to the main shaft. One skilled in the art will understand that there are various measurements suitable to measure the system output.

Next, as indicated at decisional block 830, the system determines whether the system output is optimal. In one embodiment, the system output is optimal when the ratio of the wind speed to the main shaft rpm falls within a predetermined range. In one embodiment, the system output is optimal when the generator shaft rpm falls within a predetermined range. Generally, whether the system output is optimal is a function of the specific operational objectives of the system, which are determined by the system users. As such, in one embodiment, the system output is optimal when the system output meets predetermined criteria.

If at decisional block 830 the system output is optimal, the process continues along the YES branch, returning to block 810. If at decisional block 830 the system output is not optimal, the process continues along the NO branch to decisional block 835. As indicated at decisional block 835, the system determines whether the zero point is at a predetermined minimum. As described above, in one embodiment, the zero point is at a minimum when the zero point is set such that the substantially vertical blade position is located at the center line of Zone 2 or Zone 4. Similarly, in one embodiment, the zero point is at a minimum when the zero point is located at the center line of Zone 2 or Zone 4.

In an alternate embodiment, the zero point is at a minimum when the zero point is set such that the substantially vertical blade position is located at the center line of Zone 1 or Zone 3. Similarly, in one embodiment, the zero point is at a minimum when the zero point is located at the center line of Zone 1 or Zone 3. In one embodiment, the zero point is at a minimum when further adjustment moves the zero point from the center line of a Zone. For example, one skilled in the art will understand that, as described above, adjustment of the zero point changes the efficiency of the blades in converting wind energy to torque applied to the main shaft. As such, in one embodiment, the zero point is at a minimum when additional adjustment no longer increases the blade efficiency, when the adjustment is for the purpose of increasing the blade efficiency. Similarly, in one embodiment, the zero point is at a minimum, when additional adjustment no longer decreases the blade efficiency when the adjustment is for the purpose of decreasing the blade efficiency.

If at decisional block 835 the zero point is at the minimum, the process continues along the YES branch, returning to block 810. If at decisional block 835 the zero point is not at the minimum, the process continues along the NO branch to block 840.

As indicated at block 840, the system adjusts the blade sequence zero point. In one embodiment, the system adjusts the blade sequence zero point to the minimum. In an alternate embodiment, the system adjusts the blade sequence zero point by a predetermined amount. In one embodiment, the predetermined amount is 5 degrees. Thus, in one embodiment, when the system output is non-optimal, and the blade sequence zero point is not already at a minimum, the system can adjust the blade sequence zero point to increase or decrease the blade efficiency as desired.

The process returns to block 810, wherein the system measures the wind speed. As such, the embodiments disclosed herein can be configured to respond dynamically to changing operational environmental conditions, while maintaining broad safety and efficiency targets. Moreover, in both stable and varying environmental conditions, the embodiments disclosed herein can be configured to provide fluid energy capture systems and methods superior to common systems and methods.

More particularly, the embodiments disclosed herein include a dynamic balance of blade orientations on fully rotatable axles to interactively present the proper cross-section of the blades to the wind at all times, respective of the blade's position to the wind in regard to the objective of creating maximum conversion of wind pressure to torque on the vertical windmill shaft. Thus, as generally described above, the embodiments disclosed herein provide numerous technical advantages over prior art systems and methods.

This coordinated, dynamic transitioning of the wing cross-sections gives increased efficiency to the energy capture system. In some embodiments, the improved efficiencies approach the efficiencies of propeller-driven horizontal windmills, without also suffering from some of the disadvantages of earlier approaches. Furthermore, the embodiments disclosed herein are effective in small (10,000 watts to 50,000 watts), large (100,000 watts to 250,000 watts) and mega (500,000 watts to 1.5 Mega watts) sized designs, offering improved efficiency across a broad range of power-supply requirements.

As such, generation dynamos can be developed to match optimized rotational speeds of the disclosed embodiments, and the large torques they are capable of creating, which further improves the system, resulting in a much more cost effective and cost maintainable fluid energy capture system, operating in a broad spectrum of generating ranges. Furthermore, the disclosed embodiments can be constructed using known methods, which keeps the startup cost of the systems to approximately the same equipment costs as with earlier systems. For example, with the use of common aircraft style wing construction, modified as described herein, very large embodiments can be created that can create megawatts of power.

Additionally, the disclosed embodiments are substantially omni-directional. As described above, the operation of the wings, and the dynamic transition between operational attitudes is, in part, a function of the wind direction. Accordingly, as the wind shifts, the wings naturally respond according to the Zone in which the wings are presently operating. Thus, the wings provide nearly continuous torque generation, even if the current Zone (after the wind shift) is now very different than the Zone in which the wing was before the wind shifted. As the wings rotate around the drive shaft axis, the Zones automatically reorient, as the wings continue to generate torque throughout most of their orbit. As such, the embodiments disclosed herein can be continuously aligned with the wind, without requiring complicated control structures to re-orient the windmills and/or supporting structures when the wind shifts.

For example, one skilled in the art will understand that typical vertical propeller windmills are configured with vertical blades, that is, the blades each couple to a vertical blade shaft, around which the blades are typically configured to reciprocate between two extreme orientations. Because typical blades change orientation around a vertical axis, typical vertical propeller systems use cams and linkages, or chains and sprockets, to reorient the vertical blades on their blade shafts. Consequently, typical cam/linkage (and chain/sprocket) configurations include linkages that must run from the control systems (typically located near the main shaft), out to the periphery of the windmill and the blades themselves.

But the disclosed embodiments overcome these disadvantages. For example, as described above, the disclosed embodiments couple the blades to the main shaft through planet and sun gears. Consequently, preferred embodiments couple the blades to horizontal blade shafts, which, as described above, can be controlled by the sun gear from a central location. As such, one skilled in the art will understand that the disclosed embodiments therefore also operate in a more fluid motion than earlier systems.

More specifically, in the disclosed embodiments the blades are configured to create torque both from the interaction with the wind as well as the rotation of the blades about their axes. Thus, the disclosed embodiments capture energy in both the revolution around the main shaft axis (as in conventional systems), as well as in their reorientation as they progress through the sequence of blade orientations. Additionally, one skilled in the art will understand that the rotary movement of the blades in the disclosed embodiment is generally more fluid than the reciprocating movement of the blades in typical systems.

Additionally, the disclosed embodiments can be configured with the gearing contained in a single, central enclosure. One skilled in the art will understand that this configuration improves efficiency while protecting the gearing from particulate matter and other debris. Moreover, the disclosed embodiments offer further advantages.

For example, as described above, in some of the disclosed embodiments, the control mechanisms are located in a central gearbox. As described above, typical vertical shaft propellers use cam and linkage (or chain and sprocket) control mechanisms that cannot be centrally located because the typical vertical shaft propellers reciprocate about a vertical axis.

In some the disclosed embodiments, however, the control mechanism can move the zero point for each blade simultaneously. For example, as described above, in one embodiment, the central gearing mechanism includes a central stationary sun gear and a plurality of planet gears. As described above, by adjusting the sun gear, the system can adjust the zero point of each blade simultaneously.

Moreover, traditional vertical propeller systems cannot operate in wind speeds exceeding a particular safe speed, which is dependent on the type and construction of the vertical propeller system. The disclosed embodiments, however, can be configured to operate in environments and wind speeds higher than is possible with traditional systems. For example, as described above, the disclosed embodiments can be configured to adjust the zero point of the blades, thereby controlling the efficiency of the blades. Typical vertical propeller systems cannot adjust the zero point to improve efficiency, but instead are mostly configured to respond to changes in wind direction. For example, in typical vertical propeller systems, the vertical blade orientations are controlled by the wind direction interacting with a wind vane. As such, typical systems cannot adjust the blade zero point for efficiency-refinement-motivated adjustments.

Thus, as the wind speed increases, the disclosed embodiments can reduce the blade efficiency to maintain the same rpm of the blades as they revolve around the main shaft axis. Moreover, as described above, if the wind speed eventually reaches a speed that exceeds even the safe operational speed of the disclosed embodiments, the control mechanism can adjust the zero point so that opposing blades counteract each other and the propeller module rpm goes to zero. Accordingly, the disclosed embodiments can continue to operate in high wind environments that would requires shutdown of some previous systems.

Similarly, the control mechanisms of the disclosed embodiments can be configured to adjust the zero point for a blade (and/or blade module) based on a variety of target operational parameters. For example, as described above, in one embodiment, the control mechanisms adjust the zero point to maintain the system beneath a maximum torque. Similarly, the disclosed control mechanisms can be configured to optimize torque (or other operational parameters) across multiple blade modules.

For example, as described above, in one embodiment, a wind capture system includes multiple blade modules (sometimes also referred to as “carousels”). Additionally, the disclosed embodiments can be configured to optimize parameters for each module individually, all or some of the modules collectively, or a suitable combination thereof. For example, in one embodiment, the control mechanisms maintain a stable torque at a predetermined optimal level for each blade module according to that blade module's particular configuration (e.g., weight, age, actual output, state of wear, etc.).

In another embodiment, the control mechanisms maintain a stable torque at a predetermined optimal level for each blade module according to that blade module's contribution to the total torque applied to the main shaft (e.g., module altitude, position, wind speed variances at different altitudes, etc.). Similarly, in another embodiment, the control mechanisms maintain a stable torque at a predetermined optimal level for each blade module according to the contribution to the total torque applied to the main shaft by the blade module group to which that blade module belongs. As such, the disclosed embodiments can provide finer control over the output of the wind capture system as a whole, while also improving efficiency and increasing the range of environmental conditions in which the system can operate.

One skilled in the art will appreciate the embodiments disclosed above, and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A vertical propeller system for capturing wind energy, comprising:
a coupling module configured to couple to a drive shaft so as to impart rotational energy from the coupling module to the drive shaft;
the drive shaft being configured to rotate about a main axis, the main axis being substantially vertical;
a first blade coupled to the coupling module, the first blade being configured to rotate about a first blade axis, the first blade axis being substantially horizontal;
the first blade further configured to progress through a first continuous, repeating sequence of first blade orientations, the first continuous, repeating sequence of first blade orientations including a first substantially vertical orientation and a first substantially horizontal orientation;
the first substantially vertical orientation presenting a maximal cross-section to a wind stream, the wind stream having a wind direction;
the first substantially horizontal orientation presenting a minimal cross-section to the wind stream;
the first blade further configured to revolve around the coupling module in response to the wind stream, based on the first blade orientation, so as to impart rotational energy to the coupling module; and
the coupling module further configured to align the first continuous, repeating sequence of blade orientations so that the first substantially vertical orientation occurs at a predetermined angle to the wind direction.

2. The vertical propeller system of claim 1, wherein the coupling module comprises a gear box, the gear box being configured to change the alignment of the first continuous, repeating sequence of blade orientations.

3. The vertical propeller system of claim 1, wherein the coupling module comprises a gear box, the gear box being configured to change the alignment of the first continuous, repeating sequence of blade orientations, based on the wind direction.

4. The vertical propeller system of claim 1, further comprising:
wherein the coupling module comprises a sun gear; and
wherein the first blade comprises a planet gear coupled to the sun gear.

5. The vertical propeller system of claim 1, wherein the coupling module comprises a worm gear, the worm gear being configured to change the alignment of the first continuous, repeating sequence of blade orientations.

6. The vertical propeller system of claim 1, wherein the coupling module is configured to change the alignment of the first continuous, repeating sequence of blade orientations based on a desired efficiency.

7. The vertical propeller system of claim 1, further comprising:
a second blade coupled to the coupling module, the second blade configured to rotate about a second blade axis, the second blade axis being substantially horizontal;
the second blade further configured to progress through a second continuous, repeating sequence of second blade orientations, the second continuous, repeating sequence of second blade orientations including a second substantially vertical orientation and a second substantially horizontal orientation;
the second substantially vertical orientation presenting a maximal cross-section to the wind stream;
the second substantially horizontal orientation presenting a minimal cross-section to the wind stream;
the second blade further configured to revolve around the coupling module in response to the wind stream, based on the second blade orientation, so as to impart rotational energy to the coupling module; and
the coupling module further configured to align the second continuous, repeating sequence of blade orientations so that the second substantially vertical orientation occurs at a predetermined angle to the wind direction.

8. The vertical propeller system of claim 7, wherein the second blade axis and the first blade axis are substantially contiguous.

9. A method for capturing wind energy, comprising:
disposing a vertical propeller windmill within a wind stream, the wind stream having a wind direction;
wherein the vertical propeller windmill comprises:
a coupling module configured to couple to a drive shaft so as to impart rotational energy from the coupling module to the drive shaft;
the drive shaft being configured to rotate about a main axis, the main axis being substantially vertical;
a first blade coupled to the coupling module, the first blade configured to rotate about a first blade axis, the first blade axis being substantially horizontal;
the first blade further configured to progress through a first continuous, repeating sequence of first blade orientations, the first continuous, repeating sequence of first blade orientations including a first substantially vertical orientation and a first substantially horizontal orientation;
the first substantially vertical orientation presenting a maximal cross-section to the wind stream;
the first substantially horizontal orientation presenting a minimal cross-section to the wind stream;
the first blade further configured to revolve around the coupling module in response to the wind stream, based on the first blade orientation, so as to impart rotational energy to the coupling module; and
the coupling module further configured to align the first continuous, repeating sequence of blade orientations so that the first substantially vertical orientation occurs at a predetermined angle to the wind direction; and
capturing the rotational energy of the drive shaft.

10. The method of claim 9, wherein the coupling module comprises a gear box, the gear box being configured to change the alignment of the first continuous, repeating sequence of blade orientations.

11. The method of claim 9, wherein the coupling module comprises a gear box, the gear box being configured to change the alignment of the first continuous, repeating sequence of blade orientations, based on the wind direction.

12. The method of claim 9, the vertical propeller windmill further comprising:
wherein the coupling module comprises a sun gear; and
wherein the first blade comprises a planet gear coupled to the sun gear.

13. The method of claim 9, wherein the coupling module comprises a worm gear, the worm gear being configured to change the alignment of the first continuous, repeating sequence of blade orientations.

14. The method of claim 9, wherein the coupling module is configured to change the alignment of the first continuous, repeating sequence of blade orientations based on a desired efficiency.

15. The method of claim 9, the vertical propeller windmill further comprising:
a second blade coupled to the coupling module, the second blade configured to rotate about a second blade axis, the second blade axis being substantially horizontal;
the second blade further configured to progress through a second continuous, repeating sequence of second blade orientations, the second continuous, repeating sequence of second blade orientations including a second substantially vertical orientation and a second substantially horizontal orientation;
the second substantially vertical orientation presenting a maximal cross-section to the wind stream;
the second substantially horizontal orientation presenting a minimal cross-section to the wind stream;
the second blade further configured to revolve around the coupling module in response to the wind stream, based on the second blade orientation, so as to impart rotational energy to the coupling module; and
the coupling module further configured to align the second continuous, repeating sequence of blade orientations so that the second substantially vertical orientation occurs at a predetermined angle to the wind direction.

16. The method of claim 9, further comprising:
determining the efficiency of the vertical propeller windmill; and
changing the alignment of the first continuous, repeating sequence of blade orientations to achieve a predetermined efficiency.

17. A system for generating electrical energy, comprising:
a first drive shaft segment configured to rotate about a main axis in response to applied torque, generating rotational energy;
a first vertical propeller module coupled to the first drive shaft, the first vertical propeller module configured to apply torque to the first drive shaft segment;
the first vertical propeller module comprising:
a coupling module configured to couple to the first drive shaft segment so as to apply torque to the first drive shaft segment;
a first blade coupled to the coupling module, the first blade configured to rotate about a first blade axis, the first blade axis being substantially horizontal;
the first blade further configured to progress through a first continuous, repeating sequence of first blade orientations, the first continuous, repeating sequence of first blade orientations including a first substantially vertical orientation and a first substantially horizontal orientation;
the first substantially vertical orientation presenting a maximal cross-section to a wind stream, the wind stream having a wind direction;
the first substantially horizontal orientation presenting a minimal cross-section to the wind stream;
the first blade further configured to revolve around the coupling module in response to the wind stream, based on the first blade orientation, so as to impart rotational energy to the coupling module; and
the coupling module further configured to align the first continuous, repeating sequence of blade orientations so that the first substantially vertical orientation occurs at a predetermined angle to the wind direction; and
a generator coupled to the first drive shaft segment; and
the generator configured to convert rotational energy of the first drive shaft segment into electrical energy.

18. The system of claim 17, further comprising:
a second drive shaft segment coupled to the first vertical propeller module, the second drive shaft segment configured to rotate about the main axis in response to applied torque, generating rotational energy;
a second vertical propeller module coupled to the second drive shaft, the second vertical propeller module configured to apply torque to the second drive shaft segment;
the second vertical propeller module comprising:
a coupling module configured to couple to the second drive shaft segment so as to apply torque to the second drive shaft segment;
a first blade coupled to the coupling module, the first blade configured to rotate about a first blade axis, the first blade axis being substantially horizontal;
the first blade further configured to progress through a first continuous, repeating sequence of first blade orientations, the first continuous, repeating sequence of first blade orientations including a first substantially vertical orientation and a first substantially horizontal orientation;
the first substantially vertical orientation presenting a maximal cross-section to the wind stream;
the first substantially horizontal orientation presenting a minimal cross-section to the wind stream;
the first blade further configured to revolve around the coupling module in response to the wind stream, based on the first blade orientation, so as to impart rotational energy to the coupling module; and
the coupling module further configured to align the first continuous, repeating sequence of blade orientations so that the first substantially vertical orientation occurs at a predetermined angle to the wind direction.

19. The system of claim 17, the coupling module of the first vertical propeller module further configured to:
detect a change in the wind direction; and
change the alignment of the first continuous, repeating sequence of blade orientations of the first vertical propeller module to maintain the predetermined angle to the wind direction.

20. The system of claim 19, the coupling module of the first vertical propeller module further configured to:
determine the efficiency of the vertical propeller windmill; and
change the alignment of the first continuous, repeating sequence of blade orientations to achieve a predetermined efficiency.
